(19) United States
(12) Patent Application Publication
(10) Pub. No.: US 2013/0345887 A1
(43) Pub. Date: Dec. 26, 2013

(54) INFRASTRUCTURE BASED COMPUTER CLUSTER MANAGEMENT

(71) Applicants: Sriram Govindan, Redmond, WA (US); Sriram Sankar, Redmond, WA (US); Woongki Baek, Redmond, WA (US)

(72) Inventors: Sriram Govindan, Redmond, WA (US); Sriram Sankar, Redmond, WA (US); Woongki Baek, Redmond, WA (US)

(73) Assignee: Microsoft Corporation, Redmond, WA (US)

(21) Appl. No.: 13/527,613

(22) Filed: Jun. 20, 2012

(51) Int. Cl. G05F 5/00; G05D 23/00

(52) U.S. Cl. 700/291; 700/286

(57) ABSTRACT

Various techniques of managing a computer cluster are disclosed herein. In one embodiment, a method for managing a computer cluster includes receiving a request for a computing operation, obtaining information of utility for the computer cluster, and determining an execution profile of the computing operation identified by the received request based at least in part on the obtained information. The information includes at least one of a configuration or condition of power, heating, cooling, ventilation that supports the computer cluster. The method also includes executing the computing operation in the computer cluster in accordance with the determined execution profile.

### BACKGROUND

Cloud computing involves delivery of computing and/or data storage as a service to one or more client devices via the Internet or other networks. Through web browsers or other applications, client devices can access cloud-based applications and/or data stored in remote computer clusters. Cloud computing may allow enterprises to deploy, manage, and maintain applications with reduced costs than traditional computing service delivery.

Computer clusters for providing cloud computing and/or other services typically include multiple computing units (e.g., servers) supported by a utility infrastructure. For example, the utility infrastructure can include transformers, rectifiers, voltage regulators, circuit breakers, substations, power distribution units, fans, cooling towers, and/or other electrical/mechanical components to allow proper operation of the computing units. For system reliability, the utility infrastructure may also include uninterrupted power supplies, diesel generators, auxiliary electrical lines, and/or other backup systems. These utility infrastructure components can be costly and complex to design, install, maintain, and operate.

### SUMMARY

The present technology is directed to techniques for managing a computer cluster based at least in part on configuration and/or conditions of utility infrastructure that supports the computer cluster. For example, aspects of the present technology include obtaining information of the utility infrastructure and determining an execution profile of a computing operation based at least in part thereon. The information can include a configuration or condition of power, heating, cooling, ventilation, or other systems that support the operation of the computer cluster. The computing operation can then be executed in the computer cluster in accordance with the determined execution profile.

Other aspects of the present technology can include determining the execution profile of the computing operation based not only on the information of the utility infrastructure but also on one or more execution characteristics of the computing operation. For example, if the computing operation is a virus scan, application update, software patch, or other operation without a rigid deadline, the computing operation may be delayed when the computer cluster is operating on an uninterrupted power supply, diesel generator, or other backup power source. As a result, the backup power source may have extended operating period and can be under provisioned to reduce capital costs while maintaining similar performance.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic block diagram illustrating a computer cluster managed in accordance with embodiments of the present technology.

FIG. 2 is a block diagram showing computing components suitable for the management controller of FIG. 1 in accordance with embodiments of the present technology.

FIG. 3 is a block diagram showing software modules suitable for the process component of FIG. 2 in accordance with embodiments of the present technology.

FIG. 4 is a flow diagram illustrating a process for managing a computer cluster in accordance with embodiments of the present technology.

FIG. 5 is a schematic block diagram illustrating another computer cluster managed in accordance with embodiments of the present technology.

### DETAILED DESCRIPTION

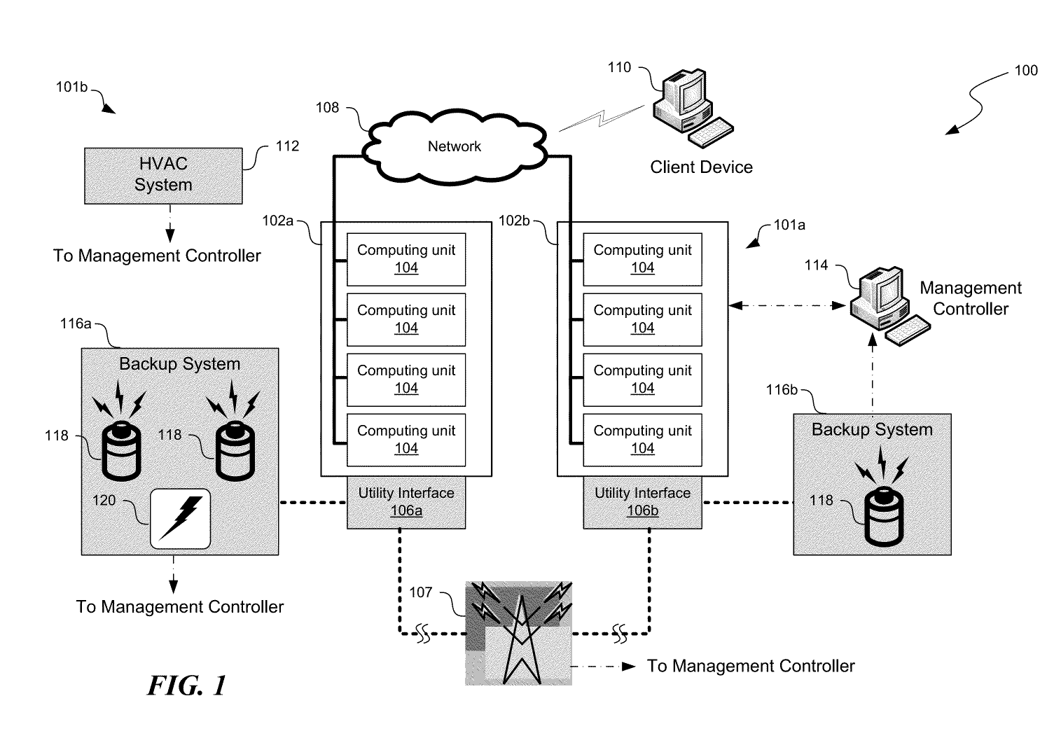

Various embodiments of utility infrastructure based systems, controllers, components, modules, routines, and processes for managing computer clusters are described below. As used herein, the phrase “computer cluster” generally refers to one or more computers connected to one another and/or to an external device by a computer network. In the following description, example software codes, values, and other specific details are included to provide a thorough understanding of various embodiments of the present technology. A person skilled in the relevant art will also understand that the technology may have additional embodiments. The technology may also be practiced without several of the details of the embodiments described below with reference to FIGS. 1-5.

Providing utility infrastructure support to computer clusters can be costly and complex. For example, provisioning and maintaining backup power sources (e.g., uninterrupted power supplies and diesel generators) require substantial capital investment and routine maintenance. Even with such backup power sources, system reliability often cannot be guaranteed because the backup power sources may fail, be exhausted, and/or otherwise unavailable. Suggestions have been made to under provision components of utility infrastructure by reducing computational load of the computer clusters. However, such a technique may adversely affect performance of the computer clusters.

Several embodiments of the present technology can address at least some of the foregoing difficulties by managing computer clusters based at least in part on configuration and/or conditions of utility infrastructure that supports the computer clusters. As used herein, the term “utility infrastructure” may, for example, refer to systems, organizations, structures, and/or components that support operations of the computer clusters. For example, the utility infrastructure can include power (e.g., electricity supply, power distribution, power rectification, etc.), heating, ventilation, and air conditioning (HVAC), cooling (e.g., cooling towers, chillers, etc.), and/or other types of systems that support the computer clusters.

FIG. 1 is a schematic block diagram illustrating an example computer cluster 100 managed in accordance with embodiments of the present technology. As shown in FIG. 1, the computer cluster 100 can include a computing subsystem 101a, a utility infrastructure 101b that supports the computing subsystem 101a, and a management controller 114 in communication with both the computing subsystem 101a and the utility infrastructure 101b. In FIG. 1, components of the utility infrastructure 101b are shown with gray backgrounds for clarity.

As shown in FIG. 1, the computing subsystem 101a can include multiple computing units 104 housed in computer cabinets 102 (illustrated individually as first and second computer cabinets 102a and 102b, respectively) and coupled to a network 108. The computer cabinets 102 can have any suitable shape and/or size to house the computing units 104 in racks and/or in other suitable groupings. Though only two computer cabinets 102 are shown in FIG. 1, in other embodiments, the computing subsystem 101a can include one, three, four, or any other suitable number of computer cabinets 102 and/or other housing components.

The network 108 can include a wired medium (e.g., twisted pair, coaxial, untwisted pair, or optic fiber), a wireless medium (e.g., terrestrial microwave, cellular systems, WI-FI, wireless LANs, Bluetooth, infrared, near field communication, ultra-wide band, or free space optics), or a combination of wired and wireless media. The network 108 may operate according to Ethernet, token ring, asynchronous transfer mode, and/or other suitable link layer protocols. In further embodiments, the network 108 can also include routers, switches, modems, and/or other suitable computing/communication components in suitable arrangements.

The computing units 104 can be configured to implement one or more applications accessible by a client device 110 (e.g., a desktop computer, a smart phone, etc.) and/or other entities via a wide area network (e.g., the Internet) or through any other coupling mechanisms. Embodiments of the computing units 104 can include web servers, application servers, database servers, and/or other suitable computing components. FIG. 1 shows four computing units 104 in each computer cabinet 102 for illustration purposes. In other embodiments, one, two, three, five, or any other suitable number of computing units 104 may be carried in each computing cabinet 102.

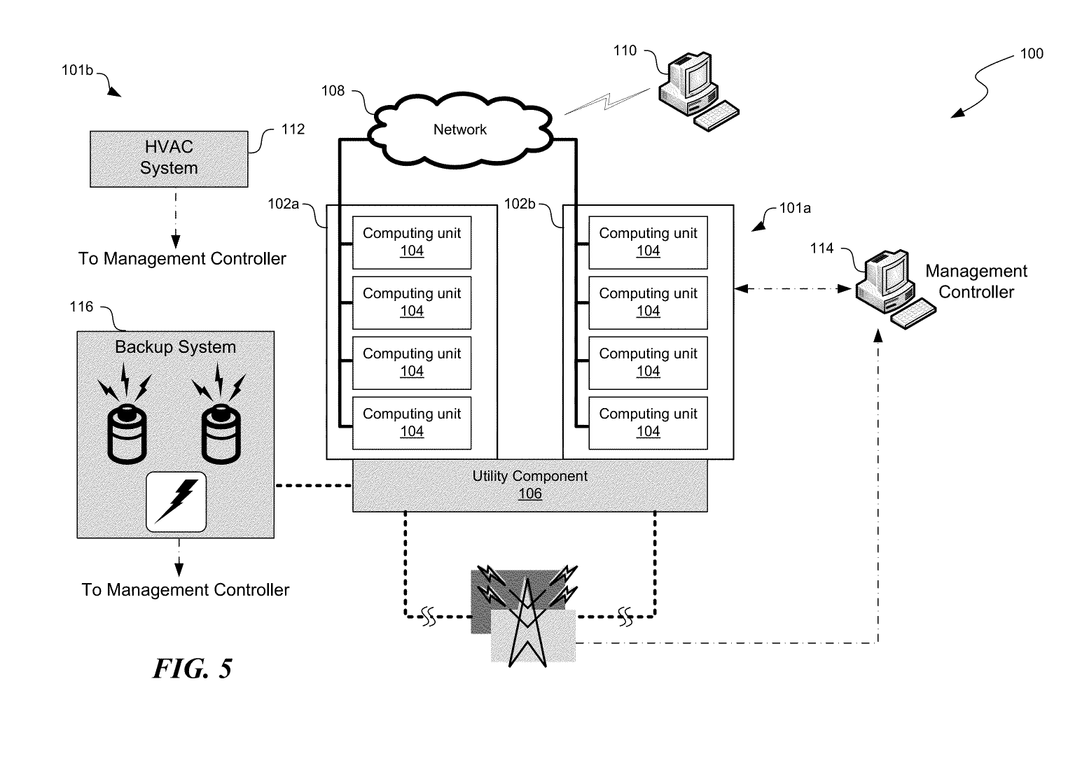

In the illustrated embodiment, the utility infrastructure 101b includes utility interfaces 106 (illustrated individually as first and second utility interfaces 106a and 106b, respectively), electrical backup systems 118 (identified individually as a first backup system 116a and a second backup system 118b), an electrical power source 107 (e.g., an electrical grid), and an HVAC system 112 configured to provide a suitable temperature and/or humidity to the computing units 104. The foregoing components of the utility infrastructure 101b shown in FIG. 1 are examples for illustrating various aspects of the present technology. In other embodiments, the utility infrastructure 101b may include other suitable components in other arrangements. One example is discussed in more detail below with reference to FIG. 5.

As shown in FIG. 1, the first and second utility interfaces 106a and 106b are associated with the first and second computer cabinets 102a and 102b, respectively. The utility interfaces 106 can be configured to covert, condition, distribute, or switch power, monitor for electrical faults, and/or otherwise interface with other components of the utility infrastructure 101b. For example, in one embodiment, the utility interfaces 106 can include a power distribution unit configured to receive power from the electrical power source 107 or the backup systems 116 and distribute power to the individual computing units 104. In other embodiments, the utility interfaces 106 can include a power conversion unit (e.g., a transformer), a power conditioning unit (e.g., a rectifier, a filter, etc.), a power switching unit (e.g., an automatic transfer switch), a power protection unit (e.g., a surge protection circuit), and/or other suitable electrical and/or mechanical components that support operation of the computing units 104.

The backup systems 116 can be configured to provide emergency or backup power to the computing units 104 when the electrical power source 107 is unavailable. In the illustrated embodiment, the first and second backup systems 116a and 116b are coupled to the first and second utility interfaces 106a and 106b, respectively. The first backup system 116a includes two uninterrupted power supplies 118 and a diesel generator 120. The second backup system 116b includes one uninterrupted power supply 118. In other embodiments, the backup systems 116 may include other suitable components in suitable arrangements.

During normal operation, the utility interfaces 106 receive electrical power from the electrical power source 107 and convert, condition, and distribute power to the individual computing units 104 in respective computer cabinets 102. The utility interfaces 106 also monitor for and protect the computing units 104 from power surges, voltage fluctuation, and/or other undesirable power conditions. When a failure of the electrical power source 107 is detected, the utility interfaces 106 can switch power supply to the backup system 116 and provide emergency power to the individual computing units 104 in respective computer cabinets 102. As a result, the computing units 104 may continue to operate for a period of time even when the electrical power source 107 is unavailable.

In conventional computer clusters, the operation of the utility infrastructure 101b is typically independent from the operation of the computing units 104. Thus, the computer units 104 may continue to execute virus scan, application update, software patch, and/or execute other applications when a failure of the electrical power source 107 is detected. Thus, to achieve a target level of backup operating period, a large amount of backup capacity may be required with associated costs and maintenance requirements.

In certain embodiments, the management controller 114 can be configured to manage operations of the computing units 104 based at least in part on configuration and/or conditions of the utility infrastructure 101b. The management controller 114 can include a personal computer, a network server, a laptop computer, and/or other suitable computing devices. By directing certain applications to computing units 104 with corresponding level of utility infrastructure support, delaying and/or slowing execution of certain computing operations, the amount of backup capacity in the utility infrastructure 101b may be reduced when compared to conventional techniques. Even though the management controller 114 is shown as an independent component in FIG. 1, in other embodiments, the management controller 114 may include one of the computing units 104 or a software service running on one of the computing units 104.

As shown in FIG. 1, the management controller 114 is in communication with the computing units 104 and the various components of the utility infrastructure 101b to monitor and/or control operations thereof. In certain embodiments, the management controller 114 may be configured to determine an execution profile of a computing operation based on at least one of (a) a configuration and/or conditions of the utility infrastructure 101b or (b) an execution characteristic of the computing operation. The execution profile may include identity of a computing unit 104 assigned to execute the computing operation, execution order, execution delay, execution priority, and/or other suitable execution characteristics. The execution characteristic can include an execution delay tolerance, an execution deadline, quality of service, and/or other suitable characteristics.

The configuration of the utility infrastructure 101b can include identity, connectivity, topography, hierarchy, and/or other structural and organizational features of the utility infrastructure 101b. The configuration can also include information of the various components of the utility infrastructure 101b. For example, such information can include a redundancy of the individual components, a mean time to fail and/or mean time to repair of at least one of the components, and a maintenance schedule of at least one of the components. In another example, such information can include a rated capacity of at least one electrical components, a runtime of an uninterrupted power supply at certain load levels, a specification of a circuit breaker, and a power factor of various electrical components.

The condition of the utility infrastructure 101b can include current and/or historical operating conditions of various components of the utility infrastructure 101b. For example, the condition can include information of an failure event of at least one of the components, an electrical power frequency, an electrical power voltage, and a utility transition time. In another example, the condition can include a start/stop event, a supply voltage, a fuel storage level, and a transition time of a diesel generator, utility spot pricing, peak demand pricing, and utility contractual limit. In further examples, the condition can include room temperature/humidity, cabinet temperature/humidity, room or cabinet ventilation condition, and/or other suitable information of the various components of the utility infrastructure 101b.

In certain embodiments, the management controller 114 can assign requested computing operations based on (a) a configuration of the utility infrastructure 101b and (b) an execution characteristic of the computing operation. For example, in the embodiment illustrated in FIG. 1, if the management controller 114 determines that the requested computing operation requires high reliability (e.g., a web search), the management controller 114 can assign the web search to one of the computing units 104 in the first computer cabinet 102a because the first backup system 116a has more backup capacity than the second backup system 116b. Thus, the computing units 104 in the first computer cabinet 102a are expected to have higher system availability than those in the second computer cabinet 102b. Conversely, if the management controller 114 determines that the requested computing operation does not require high reliability (e.g., software patch), the management controller 114 may assign the computing operation to one of the computing units 104 in the second computer cabinet 102b.

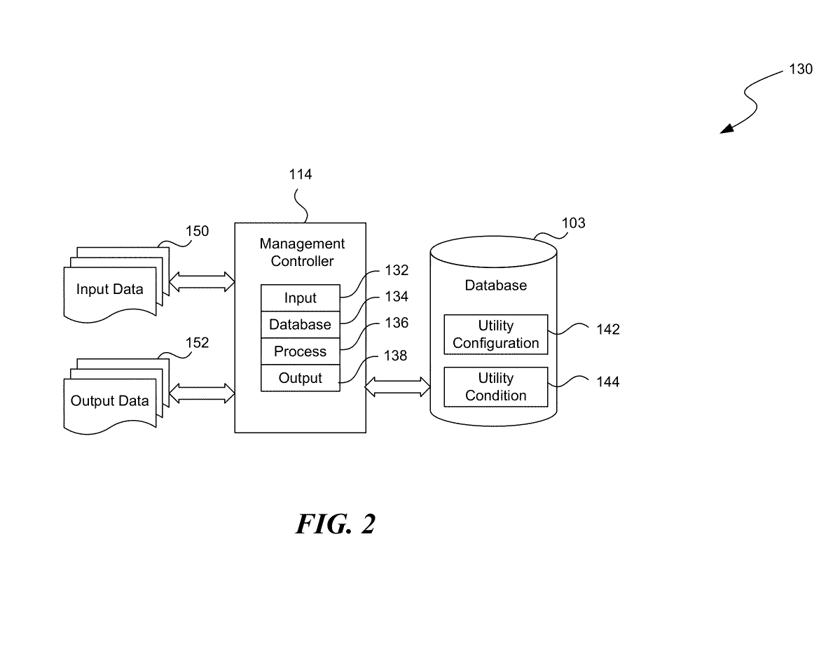

In other embodiments, the management controller 114 can regulate execution timing and/or sequence of requested computing operations based on (a) a condition of the utility infrastructure 101b and (b) an execution characteristic of the computing operation. For example, if the management controller 114 detects that the electrical power source 107 is available, the management controller 114 may adopt an execution profile that allows all computing operations to execute in sequence or according to other suitable orders. If the management controller 114 detects low voltage (commonly referred to as a “brown out”) or a total failure of the electrical power source 107, the management controller 114 may adopt an execution profile that delays or even cancels execution of certain computing operations (e.g., virus scan) based on the corresponding execution characteristic (e.g., no rigid deadline). During brown out, in one embodiment, the management controller 114 may delay and/or slow execution of computing operations in sequence until the voltage is above a threshold. In another embodiment, the management controller 114 may calculate a reduction in computational demand based on the measured voltage and delay execution of a number of the computing operations based thereon. Components and configurations of the management controller 114 are described in more detail below with reference to FIGS. 2-5.

FIG. 2 is a block diagram showing computing components suitable for the management controller 114 of FIG. 1 in accordance with embodiments of the present technology. In FIG. 2 and in other Figures hereinafter, individual software components, modules, and routines may be a computer program, procedure, or process written as source code in C, C++, Java, and/or other suitable programming languages. The computer program, procedure, or process may be compiled into object or machine code and presented for execution by a processor of a personal computer, a network server, a laptop computer, a smart phone, and/or other suitable computing devices. Various implementations of the source and/or object code and associated data may be stored in a computer memory that includes read-only memory, random-access memory, magnetic disk storage media, optical storage media, flash memory devices, and/or other suitable storage media excluding propagated signals.

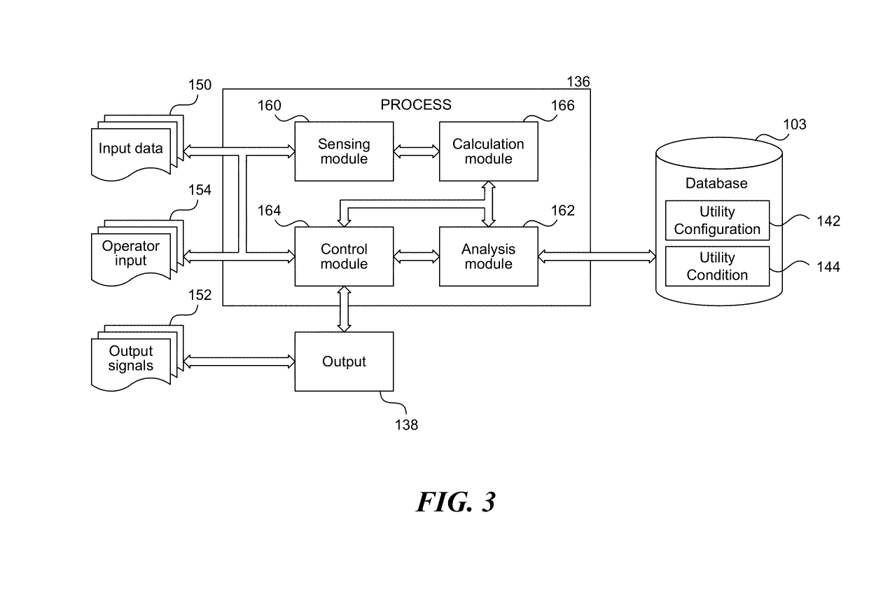

As shown in FIG. 2, the input component 132 may accept communication input data 150, such as requested computing operations from the client device 110 (FIG. 1), configuration and/or conditions of the various components of the utility infrastructure 101b (FIG. 1), and communicates the accepted information to other components for further processing. The database component 134 organizes records, including utility configuration records 142 and utility condition records 144, and facilitates storing and retrieving of these records to and from the database 103. Any type of database organization may be utilized, including a flat file system, hierarchical database, relational database, or distributed database, such as provided by a database vendor such as the Microsoft Corporation, Redmond, Wash. The process component 136 analyzes the input data 150, and the output component 138 generates output data 152 based on the analyzed input data 150. Embodiments of the process component 136 are described in more detail below with reference to FIG. 3.

FIG. 3 is a block diagram showing software modules 130 suitable for the process component 136 in FIG. 2 in accordance with embodiments of the present technology. As shown in FIG. 3, the process component 136 can include a sensing module 160, an analysis module 162, a control module 164, and a calculation module 166 interconnected with one other. Each module may be a computer program, procedure, or routine written as source code in a conventional programming language, or one or more modules may be hardware modules.

The sensing module 160 is configured to receive the input data 150 and converting the input data 150 into suitable engineering units. For example, the sensing module 160 may receive a voltage, frequency, phase, and/or other suitable types of input from the electrical power source 107 (FIG. 1) and convert the received input to corresponding engineering units and/or a digital value of NORMAL or FAILURE. In another example, the sensing module 160 may receive an input from the backup systems 116 (FIG. 1) and/or the HVAC system 112 (FIG. 1) and convert the received input to a digital value of ON or OFF, a start/stop event, a supply voltage, a fuel storage level, and a transition time. In yet another example, the sensing module 160 may receive utility spot pricing, peak demand pricing, and utility contractual limit from a public utility and/or other suitable external sources. In further examples, the sensing module 160 may perform other suitable conversions.

The calculation module 166 may include routines configured to perform various types of calculations to facilitate operation of other modules. For example, the calculation module 166 can include routines for averaging an electrical voltage of the electrical power source 107 received from the sensing module 160. In another example, the calculation module 166 can calculate a reduction in computational demand based on the measured electrical power voltage during a brown out event. The reduction in computational demand may be calculated according to a predetermined coefficient, empirical data, and/or other suitable criteria. In other examples, the calculation module 166 can include linear regression, polynomial regression, interpolation, extrapolation, and/or other suitable subroutines. In further examples, the calculation module 166 can also include counters, timers, and/or other suitable routines.

The analysis module 162 can be configured to analyze the monitored and/or calculated parameters from the sensing module 160 and the calculation module 166 and to determine an execution profile for a computing operation. For example, the analysis module 162 may compare the measured voltage of the electrical power source 107 to a predetermined brown out threshold. If the measured voltage is below the threshold, the analysis module 162 can indicate a brown out event. If the measured voltage is below a failure threshold, the analysis module 162 can indicate a utility failure of the electrical power source 107.

The analysis module 162 can also be configured to determine an execution profile of a requested computing operation. For example, in one embodiment, the analysis module can analyze (a) a configuration of the utility infrastructure 101b and (b) an execution characteristic of the computing operation to determine an assignment of the computing operation to a particular computing unit 104. In another embodiment, the analysis module can analyze (a) a condition of the utility infrastructure 101b and (b) an execution characteristic of the computing operation to determine an execution priority of the computing operation. Certain examples of operations of the analysis module 162 are described in more detail below with reference to FIG. 5.

The control module 164 may be configured to control the operation of the computing units 104 (FIG. 1) based on analysis results from the analysis module 162. For example, in one embodiment, if the analysis module 162 indicates a brown out event, the control module 164 can generate an output signal 152 to delay and/or slow execution of computing operations and provide the instruction to the output module 138. In other embodiments, the control module 164 may also generate output signal 152 based on operator input 154 and/or other suitable information.

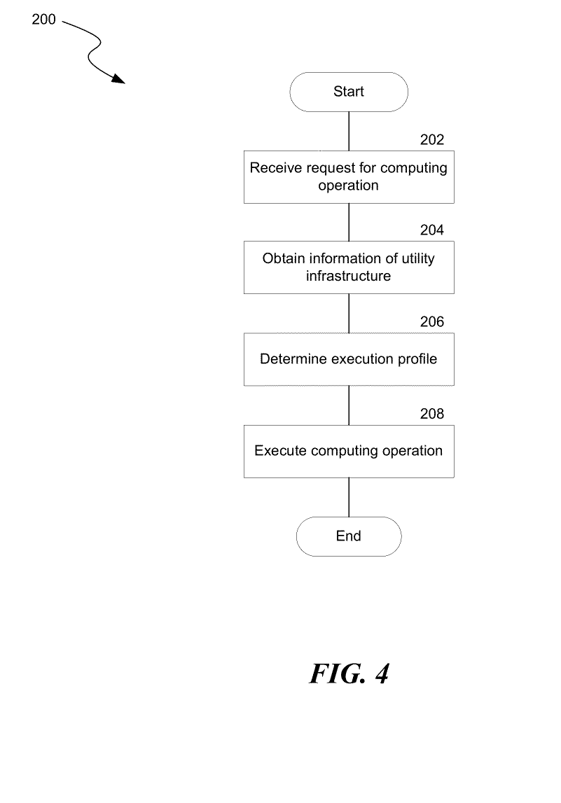

FIG. 4 is a flow diagram illustrating a process 200 for managing a computer cluster in accordance with embodiments of the present technology. Even though the process 200 is described below with reference to the computer cluster 100 of FIG. 1, embodiments of the process 200 may be implemented in computer clusters with different and/or additional components or arrangements. As shown in FIG. 4, one stage 202 of the process 200 can include receiving a request for a computing operation at the management controller 114 (FIG. 1). The request may be generated by the client device 110 (FIG. 1), from within the computer cluster 100, or from other suitable sources. The computing operation can include virus scan, application update, software patch, web search, file download, and/or other computing operations. In certain embodiments, the requested computing operation may have one or more execution characteristics that include at least one of priority identification, delay tolerance, or computational demand.

Another stage 204 of the process 200 can include obtaining information of the utility infrastructure 101b (FIG. 1) by the management controller 114. In certain embodiments, the obtained information can include configuration information of the utility infrastructure 101b. For example, the information can include a connectivity topology of electrical components, a redundancy of the individual electrical components, a mean time to fail and/or mean time to repair of at least one of the electrical components, and a maintenance schedule of at least one of the electrical components. In another example, the electrical components can include at least some of a utility substation, a diesel generator, a uninterrupted power supply, a circuit breaker, and a transformer. The information can include a rated capacity of at least one of the electrical components, a runtime of the uninterrupted power supply at certain load levels, a specification of the circuit breaker, and a power factor of the electrical components. In certain embodiments, the configuration information may be stored in the database 103 (FIG. 2) as utility configuration records 142 and obtained with the database component 134 (FIG. 2) of the management controller 114. In other embodiments, the information may be stored in other suitable locations as a configuration file and/or other suitable types of file.

In other embodiments, the obtained information can include condition information of various components of the utility infrastructure 101b. For example, the information can also include a start/stop event, a supply voltage, a fuel storage level, and a transition time of a diesel generator. In another example, the information can include a failure event of at least one of the electrical components, an electrical power frequency, an electrical power voltage, and a utility transition time. In yet further examples, the information can include utility spot pricing, peak demand pricing, and utility contractual limit.

Another stage 206 of the process 200 can include determining an execution profile for the computing operation based at least in part on the obtained information with the management controller 114. The execution profile can include at least one of an execution priority, execution delay, node assignment, or execution sequence of the computing operation. In one embodiment, the execution profile includes assigning the computing operation to a particular computing unit 104 with a particular level of utility infrastructure support (e.g., high backup capacity) if the computing operation requires certain execution characteristic (e.g., high reliability). In another embodiment, the execution profile includes a delay and/or slow execution of the computing operation when at least one of the following conditions exists:
a utility failure and transition to an uninterrupted power supply;
a utility failure and transition to a diesel generator;
a measured electrical power voltage (current or averaged) is below a preset threshold;
a measured frequency of the power supply fluctuates above a preset threshold;
utility spot pricing or peak demand pricing above a preset threshold;
utility contractual limit exceeded.
   In other embodiments, the computing operation may be delayed based on other suitable conditions.

In further embodiments, determining the execution profile can include calculating a reduction in computational demand based on the measured electrical power voltage and delay and/or slow execution of at least one of the computing operations accordingly. In yet further embodiments, multiple computing operations may be sequentially delayed until the measured electrical power voltage is above a preset threshold. Subsequent to determining the execution profile, the process 200 can include executing the computing operation according to the determined execution profile at stage 208.

FIG. 5 is a schematic block diagram illustrating another computer cluster 100 in accordance with embodiments of the present technology. The computer cluster 100 in FIG. 5 can be generally similar in structure and function as that in FIG. 1 except that a single utility interface 106 and a backup system 116 are associated with both the first and second computer cabinet 102a and 102b. As shown in FIG. 5, As a result, the computing units 104 in each of the computer cabinets 102 share a single backup system 116. Even though not shown in FIG. 6, the utility infrastructure 101b may have other suitable configurations.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A method for managing a computer cluster, comprising:
receiving a request for a computing operation;
obtaining information of utility infrastructure for the computer cluster, the infrastructure information including at least one of a configuration or condition of power, heating, cooling, ventilation that supports the computer cluster;
determining an execution profile of the computing operation identified by the received request based at least in part on the obtained information; and
executing the computing operation in the computer cluster in accordance with the determined execution profile.

2. The method of claim 1 wherein:
the received request includes one or more execution characteristics of the computing operation; and
determining the execution profile includes determining at least one of an execution priority, execution delay, node assignment, or execution sequence of the computing operation based a combination of the one or more execution characteristics of the application and the obtained information.

3. The method of claim 1 wherein:
the received request includes one or more execution characteristics of the computing operation, the one or more execution characteristics including at least one of priority identification, delay tolerance, and computational demand; and
determining the execution profile includes determining at least one of an execution priority, execution delay, node assignment, or execution sequence of the computing operation based on a combination of the one or more execution characteristics of the application and the obtained information.

4. The method of claim 1 wherein:
the infrastructure configuration including connectivity topology of electrical components coupled to the computer cluster; and
obtaining information includes obtaining information of at least one of a redundancy of the individual electrical components;
a mean time to fail and/or mean time to repair of at least one of the electrical components; and
a maintenance schedule of at least one of the electrical components.

5. The method of claim 1 wherein:
the infrastructure configuration including connectivity topology of electrical components coupled to the computer cluster, the electrical components including at least some of a utility substation, a diesel generator, a uninterrupted power supply, a circuit breaker, and a transformer;
obtaining information includes obtaining information of at least one of
a rated capacity of at least one of the electrical components;
a runtime of the uninterrupted power supply at certain load levels;
a specification of the circuit breaker; and
a power factor of the electrical components.

6. The method of claim 1 wherein:
the infrastructure configuration including connectivity topology of electrical components coupled to the computer cluster; and
obtaining information includes obtaining information of an failure event of at least one of the electrical components, an electrical power frequency, an electrical power voltage, and a utility transition time.

7. The method of claim 1 wherein:
the infrastructure includes a diesel generator coupled to the computer cluster; and
obtaining information includes obtaining information of a start/stop event, a supply voltage, a fuel storage level, and a transition time of the diesel generator.

8. The method of claim 1 wherein obtaining information includes obtaining information of utility spot pricing, peak demand pricing, and utility contractual limit.

9. A controller for managing a computer cluster, comprising:
an interface configured to receive a request for a computing operation to be executed in the computer cluster;
a database component configured to retrieve a configuration of utility infrastructure that supports the computer cluster;
an input component configured to monitor a condition of the utility infrastructure; and
a process component configured to determine an execution profile of the computing operation based on at least one of the retrieved configuration or the monitored condition of the utility infrastructure, the process component is also configured to cause the computing operation to be executed in the computer cluster in accordance with the determined execution profile.

10. The controller of claim 9 wherein:
the received request includes one or more execution characteristics of the computing operation; and
the process component is configured to determine at least one of an execution priority, execution delay, node assignment, or execution sequence of the computing operation identified by the received request based on a combination of the retrieved configuration of the infrastructure, the monitored condition of the infrastructure, and the one or more execution characteristics of the computing operation.

11. The controller of claim 9 wherein:
the input component is configured to detect a utility failure and transition to an uninterrupted power supply; and
the process component is configured to extending a runtime of the uninterrupted power supply by delaying and/or slowing execution of the computing operation when a utility failure and transition to the uninterrupted power supply is detected.

12. The controller of claim 9 wherein:
the input component is configured to detect a utility failure and transition to a diesel generator; and
the process component is configured to delaying and/or slowing execution of the computing operation when a utility failure and transition to the diesel generator is detected.

13. The controller of claim 9 wherein:
the input component is configured to measure an electrical power voltage supplied to the computer cluster; and
the process component is configured to delay and/or slowing execution of the computing operation when the measured electrical power voltage is below a preset threshold.

14. The controller of claim 9 wherein:
the interface is configured to receive a plurality of requests that correspond to a plurality of computing operations to be executed in the computer cluster;
the input component is configured to measure an electrical power voltage to the computer cluster;
the process component includes a calculation routine configured to calculate a reduction in computational demand based on the measured electrical power voltage and delay and/or slowing execution of at least one of the computing operations based on the calculated reduction in computational demand.

15. The controller of claim 9 wherein:
the interface is configured to receive a plurality of requests that correspond to a plurality of computing operations to be executed in the computer cluster;
the input component is configured to measure an electrical power voltage to the computer cluster; and
when the measured electrical power voltage is below a preset threshold, the process component is configured to sequentially stop execution of at least some of the computing operations until the measured electrical power voltage is above the preset threshold.

16. The controller of claim 9 wherein:
the interface is configured to receive a plurality of requests that correspond to a plurality of computing operations to be executed in the computer cluster, the individual computing operations having one or more execution characteristics including at least one of priority identification, delay tolerance, or computational demand;
the input component is configured to measure an electrical power voltage to the computer cluster; and
when the monitored electrical power voltage is below a preset threshold, the process component is configured to sequentially stop execution of at least some of the computing operations based on the one or more execution characteristics of the individual computing operations until the monitored electrical power voltage is above the preset threshold.

17. A computer-implemented method for managing a computer cluster, comprising:
receiving a request for a computing operation to be executed in the computer cluster, the received request including one or more execution characteristics of the computing operation, the one or more execution characteristics including at least one of priority identification, delay tolerance, reliability, and computational demand;
obtaining information of utility for the computer cluster, the information including at least one of
connectivity topology of electrical components coupled to the computer cluster;
a redundancy of the individual electrical components;
a mean time to fail and/or mean time to repair of at least one of the electrical components;
a maintenance schedule of at least one of the electrical components that supports the computer cluster; and
a rated capacity of at least one of the electrical components;
determining an execution profile having at least one of an execution priority, execution delay, node assignment, or execution sequence of the computing operation based on a combination of the one or more execution characteristics of the application and the obtained information; and
executing the computing operation in the computer cluster in accordance with the determined execution profile.

18. The computer-implemented method of claim 17 wherein determining an execution profile includes assigning the computing operation identified by the received request to a node in the computer cluster based on the one or more execution characteristics of the computing operation and the obtained information.

19. The computer-implemented method of claim 17 wherein determining an execution profile includes assigning the computing operation identified by the received request to a node in the computer cluster when the computing operation has a reliability value greater than a reliability threshold, the node being connected to at least one of an uninterrupted power supply, a diesel generator, or a backup power source.

20. The computer-implemented method of claim 17 wherein determining an execution profile includes delaying and/or slowing execution of the computing operation if the computing operation has a delay tolerance greater than a delay threshold.
